(19) United States
(12) Patent Application Publication
(10) Pub. No.: US 2010/0085894 A1
(43) Pub. Date: Apr. 8, 2010

(54) Apparatus And Method For Mapping A Wired Network

(75) Inventors: Kevin M. Johnson, Natick, MA (US); Paul C. M. Hilton, Millis, MA (US); Jeffrey A. Mehlman, Sharon, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: OUTSMART POWER SYSTEMS, LLC, Natick, MA (US)

(21) Appl. No.: 12/447,138

(22) PCT Filed: Oct. 29, 2007
(86) PCT No.: PCT/US07/82909

§ 371 Date: Dec. 7, 2009

Related U.S. Application Data
(60) Provisional application No. 60/863,328, filed on Oct. 27, 2006.
(60) Provisional application No. 60/944,645, filed on Jun. 18, 2007.

(51) Int. Cl. H04L 12/28

(52) U.S. Cl. 370/254; 370/400

(57) ABSTRACT

The present disclosure relates to a device, system and method for generating an electrical wiring diagram of an electrical network containing nodes by determining node locations with respect to other nodes and mapping the nodes. The nodes may include a processor, a sensor and a low voltage power supply and may be configured to supply and detect an electrical signal. A processor may also be provided, which may be configured to identify the node locations in the network relative to other nodes and performing the function of mapping.

### CROSS-REFERENCE TO RELATED APPLICATIONS

This application claims the benefit of U.S. Provisional Application No. 60/863,328, filed on Oct. 27, 2006 and U.S. Provisional Application No. 60/944,645, filed on Jun. 18, 2007, the disclosures of which are incorporated herein.

### FIELD OF THE INVENTION

The present disclosure relates to a system and method for mapping a wired network containing nodes, which may be configured to identify themselves, determining node locations with respect to other nodes and generating an electrical wiring diagram.

### BACKGROUND

When buildings are constructed, there may or may not be a detailed plan for the deployment of electrical fixtures in the design schematics. If one does exist, over the course of the construction, the plan may frequently change “on the fly” due to the changing needs of the customer or individual decisions by electricians—while the original plans remain unchanged. When an electrical installation job is complete, typically, an electrician may place a few words on a paper label on the inside cover of electrical service box, notating things like “stove,” “refrigerator,” “2nd floor bedroom” or perhaps “front offices,” but knowing what devices (outlets, switches . . . etc.) are actually connected to a particular circuit or to each other, may remain a mystery—the answer is in a tangle of wires behind the walls or above the ceiling.

When there are problems with electrical service and/or if future work needs to be done within a building, a large amount of time may be invested to figure out how the building is wired. For example, trying to evaluate and diagnose safety problems may be difficult, since knowing how a circuit is laid out could be central to understanding and diagnosing the cause. Additionally, before any electrical rework is completed on a building, it may be important to know how existing devices are connected to one another and to which breakers/circuits they belong.

In addition to the above, with the increasing emphasis on energy costs and efficiency, the ability to properly monitor power usage within a house or building is becoming ever more important. Knowing what devices are connected to a particular circuit, and in fact, how they are connected to one another and physically located within a building may provide much more information about how and where energy is being used. Monitoring power usage and costs may provide building owners and/or occupants a better understanding of how to adjust their usage to reduce both their costs and the load on the power system.

### SUMMARY

An aspect of the present disclosure relates to a system for determining the electrical connections for a network of wired nodes. The system may include an electrical power distribution system, a plurality of nodes connected to the power distribution system. Each of the nodes may be configured to supply and detect a node electrical signal such that the direction from which the node electrical signal was supplied can be ascertained. Furthermore, the system may be configured to identify the wiring configuration of the nodes relative to other nodes based upon the node electrical signal.

Another aspect of the present disclosure relates to a system for determining the electrical connections for a network of wired nodes. The system may include at least three nodes connected to a common bus, wherein each of the nodes is configured to supply and detect a node electrical signal along the common bus such that the direction from which the node electrical signal was supplied can be ascertained by each node. Furthermore, the system may be configured to identify the wiring configuration of the nodes relative to other nodes based upon the node electrical signal.

Another aspect of the present disclosure relates to a node. The node may include a conductive pathway, a sensor in communication with the conductive pathway configured to measure current and/or voltage in said conductive pathway, a switchable load connected to the conductive pathway and a microcontroller in communication with the sensor and the switchable load, configured to send and receive a node electrical signal and ascertain the directionality of signals sent from other such nodes.

A further aspect of the present disclosure relates to a method for identifying unintended power dissipation which constitutes an unsafe condition. The method may include identifying at least one upstream node and at least one downstream node, identifying power transmitted through the upstream node to be delivered to the downstream node, determining a difference between the power transmitted by the upstream node and the power drawn from or through the downstream node and determining if there is a level of unsafe power dissipation and providing an alert or removing power from a node upstream of where the unintended power dissipation may have occurred.

Another aspect of the present disclosure relates to a method for mapping. The method may include providing a plurality of nodes on a power distribution network, each of the nodes configured to supply and detect a node electrical signal. A processor may be provided for initiating a roll call, identifying the plurality of nodes, and identifying the wiring configuration of the nodes relative to one another based upon the node electrical signals.

### BRIEF DESCRIPTION OF DRAWINGS

The features described herein, and the manner of attaining them, may become more apparent and better understood by reference to the following description of embodiments taken in conjunction with the accompanying drawings, wherein:

FIG. 1 is a schematic illustration of an exemplary system contemplated herein;

FIG. 2 is a schematic of an example of node electronics;

FIG. 3 is a schematic diagram of a duplex outlet receptacle and an example of node electronics for the receptacle;

FIG. 4 is a schematic diagram of node electronics in a two-way switch;

FIG. 5 is a schematic diagram of node electronics in a three-way switch;

FIG. 6 is a schematic diagram of nodes wired in “parallel” versus nodes wired in “series.”

FIG. 7 is a schematic diagram of node electronics for use in a breaker;

FIG. 8 is an example of a method of synchronizing.

FIG. 9 is an example of methods for associating nodes with a particular circuit.

FIG. 10 is an example of a method for mapping nodes within a circuit.

FIG. 11a is an example of a display interface for interacting with the system including a map of the nodes on the circuit;

FIG. 11b is an example of a display interface for interacting with the system displaying information regarding a particular node on the circuit;

FIG. 12a is an example of a display interface providing information regarding power usage throughout a building;

FIG. 12b is an example of a display interface providing information regarding the cost of power usage throughout a building;

FIG. 13a is an example of a display interface providing information regarding the usage of power in a single room and the relative location of nodes throughout the room; and

FIG. 13b is an example of a display interface providing information regarding the usage of power for a single node.

### DETAILED DESCRIPTION

The present disclosure relates to a system and method for mapping a wired network containing nodes which may be configured to identify themselves to a central processor or identify themselves with respect to one other due to their own distributed processing capability. The connection of the nodes may then be determined with respect to other nodes from which an electrical wiring diagram may be generated. For example, a central processor (e.g. a computer), which may coordinate and collect node communications and information, may be connected or integrated into a breaker panel or any location within any given building, or even positioned at a remote location. A visual display may then be provided to analyze/review the electrical system, including the electrical wiring diagram, usage for given circuits or rooms, and/or usage for specific nodes. Furthermore, any aspect of this information regarding the electrical system may be forwarded to a remote location and accessed, e.g., over the Internet or any desired information network.

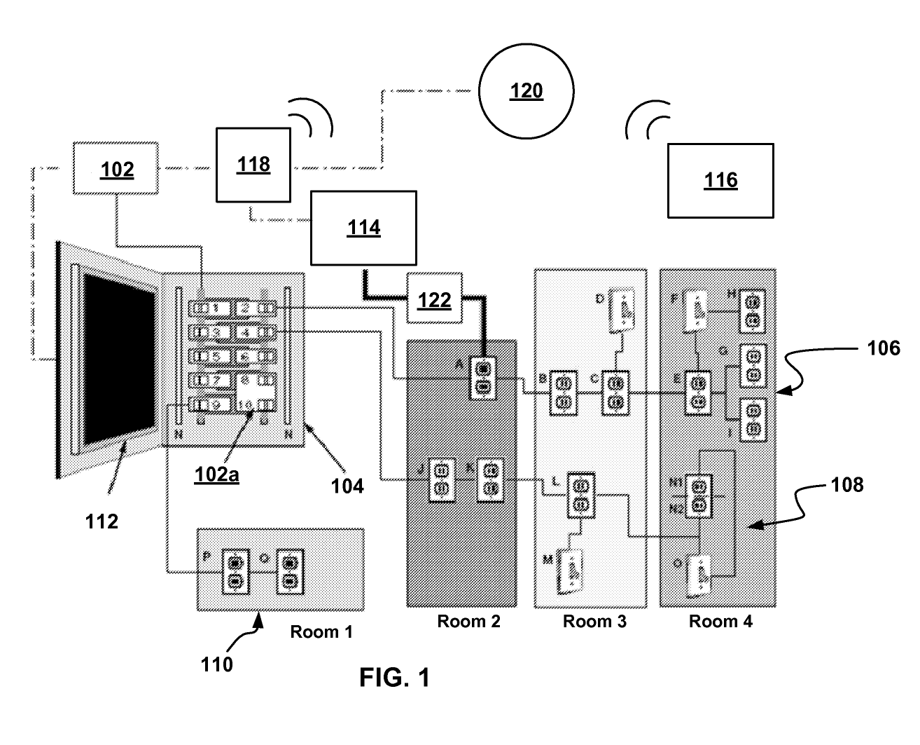

An overview of an example of the system architecture contemplated herein is illustrated in FIG. 1. The system may include a central processor 102, and/or distributed processing capabilities, an electrical distribution system or power supply (e.g. as a breaker box 104) and a series of nodes A-Q located along three circuits 106, 108 and 110 connected to breaker nodes #2, #4 and #9 and other breaker nodes #1, #3, #5, #6 and #7. The nodes may include electronics configured to monitor power usage and other conditions in the nodes and signals sent between the nodes and/or the central processor 102. The processor, or portions of its functions, may be remotely located and communicated via wireless techniques, phone, internet, power line or cable. The processor may also interface with the network at any of the node locations.

A processor as referred to herein may be any device or devices which may be configured to carry out one or more of the following: coordinate communication, control directional events at the nodes, run algorithms to determine topology and analyze power, as well as provide external communication to other devices through means such as phone, ethernet, internet, cable, wireless, etc. The processor may communicate over the electrical distribution system, be integrated into the system or located remotely. In one example, a processor 102a may be positioned in a circuit breaker position within a breaker box (104) and may communicate to multiple phases simultaneously. In another embodiment, the functions of the processor are handled on a distributed basis by computational power and memory available at each node.

In addition, reference to distributed processing herein may be understood as a technique of processing in which different parts of a program may be run on two or more processors that are in communication with one another over a network (as noted below, e.g., between two or more nodes). Accordingly, each node may be aware of at least one other node to communicate with, such that the plurality of nodes may be linked. Coordinating may be done on a cooperative basis, for example for synchronization (as explained more fully below) any node could establish a relative synchronization with any other, one pair at a time, until all of the nodes are synchronized. A similar process may occur for mapping (discussed more fully below). In addition, when data is required to be read for the system the request for information could be sent among the nodes until one or many nodes may respond.

“Nodes” may be understood herein as switches, outlets, breakers, connectors, junction boxes, lighting loads and many other hard wired devices or locations where connections may be made, and may include electronics at these locations for communicating with the system and monitoring conditions. The term “node” may also be applied to devices which are plugged into a circuit if they are so enabled with a means for communicating with the system. The node may be associated with other nodes in a circuit or with a given location in a building. Furthermore, the node may provide additional functionality, such as providing power to an outlet under specific conditions, e.g. all prongs being inserted simultaneously into an outlet.

Referring back to FIG. 1, each of the three circuits 106, 108, 110 depicted may contain a variety of switches and outlets which may provide routing of power throughout a building. For example, breaker #2 provides power to outlets A, B, C, E, H, G and I, and also to switches D and F. It may be understood that electrical devices and loads within a building are electrically wired in one or more circuits. A circuit may be understood as a path for the flow of current, which may be closed. Circuits may also be wired in “parallel.” When wired in “parallel,” disconnecting one device will not prevent the others from working. However, it may be appreciated that some devices may be wired in “series,” wherein the devices may be dependent on other devices to provide power through an electrical connection in the device itself. In other words, disconnecting an upstream device will disable downstream devices. For example, on breaker #2, power to outlets E, G, I, H and switch F in Room 4 may be dependent on outlets A, B and C, i.e. if any of these are disconnected, outlets E, G, I, H and switch F in Room 4 may not have power since each of outlets A, B and C use an electrical bus in their housings to provide power to the next outlet. However, outlets G and I are not dependent on one another and both may maintain power if the other is disconnected.

Furthermore, it may be appreciated that the nodes may be connected to a common bus, or pathway, i.e., the circuit. As understood herein, a common bus may be understood as providing electrical continuity between at least one connection on each of the nodes. Furthermore, it may be appreciated that one or more additional common busses may be provided for the nodes.

Upon direction from processor 102, which may be prompted by a user action into the interface 112, each of the nodes included in the outlets, switches, etc., may be configured to create and detect a node electrical signal. The signal may be a directional and detectable electrical signal that may be utilized to map the nodes. That is, a node's location in a virtual electrical wiring diagram may be determined by creating a detectable signal at the node, which can be relayed to identify its position to a user in such a diagram. The directional electrical event may be understood as an electrical signal that may be detected differently by upstream nodes as compared to downstream nodes. Upstream nodes may be wired electrically in the path of flowing current proximal to the primary power source relative to other nodes. Downstream nodes may be wired electrically in the path of flowing current distal to the primary power source relative to other nodes. For example for node E, nodes A, B, C and #2 (breaker) may be considered upstream nodes, and nodes F, G, H and I may be considered downstream nodes.

Depending on the signal method used, node D may or may not be considered an upstream node. For example, if the signal is generated by node E by creating an incremental electrical load, node D does not detect the flow of power. If the signal generated by node E is a voltage signal, node D may see the signal and be considered upstream. The algorithm for creating a map of the network (see below) can take into account what kind of signaling method is utilized. An incremental load may be understood as a current draw, in addition to those otherwise present in the circuit, with a sufficiently high source impedance that may have a relatively minimal effect upon the voltage on the wiring; such a signal may be at a lower frequency. A voltage signal may be understood as a power source with a sufficiently low source impedance that it is detectable as a change in voltage on the wiring; such a signal may be at a relatively higher frequency.

Each node may have a set of other nodes that are upstream and downstream from it. An accumulated table of information about which nodes are upstream and downstream from other nodes may then allow for the creation of an electrical wiring diagram. Some nodes may share the same set of upstream and/or downstream nodes, because they are electrically equivalent, for example, in FIG. 1, nodes G and I. The processor, such as central computer 102 may coordinate the sequence of directional events at each node, collect information regarding which nodes detect electrical events of other nodes, and develop a wiring diagram. The processor may also collect information regarding power usage and other data at each node and may compile the data for transmission through wireless or wired means for local viewing and interaction, e.g., interface 112, another computer 114 connected to the system, or a mobile computer 116, which may wirelessly communicate with a router 118 in either direct or indirect (as illustrated) communication with the system, or transmission to a remote location 120, such as over the internet. This information may also be retrieved directly through the power network through an appropriate interface 122.

In an illustrative embodiment, a directional electrical event may be created by a switched known load at each node. By using the power monitoring devices within each node, and by measuring the power that flows through each node, each upstream node may detect the load of a downstream node and a wiring diagram may be created. This process may be done in the presence of other loads, i.e. the switched load may be incremental to existing loads. A further enhancement includes a node having a remote current sensor (e.g. tethered) for measuring current that flows through an electrical or junction box but not through the device itself (described further herein). Using remote current sensors, outlets that would otherwise be electrical “equivalents” may be physically ordered in the wiring diagram (e.g., all nodes are wired using a pig-tail configuration and do not carry power to other nodes using an internal bus, further discussed below).

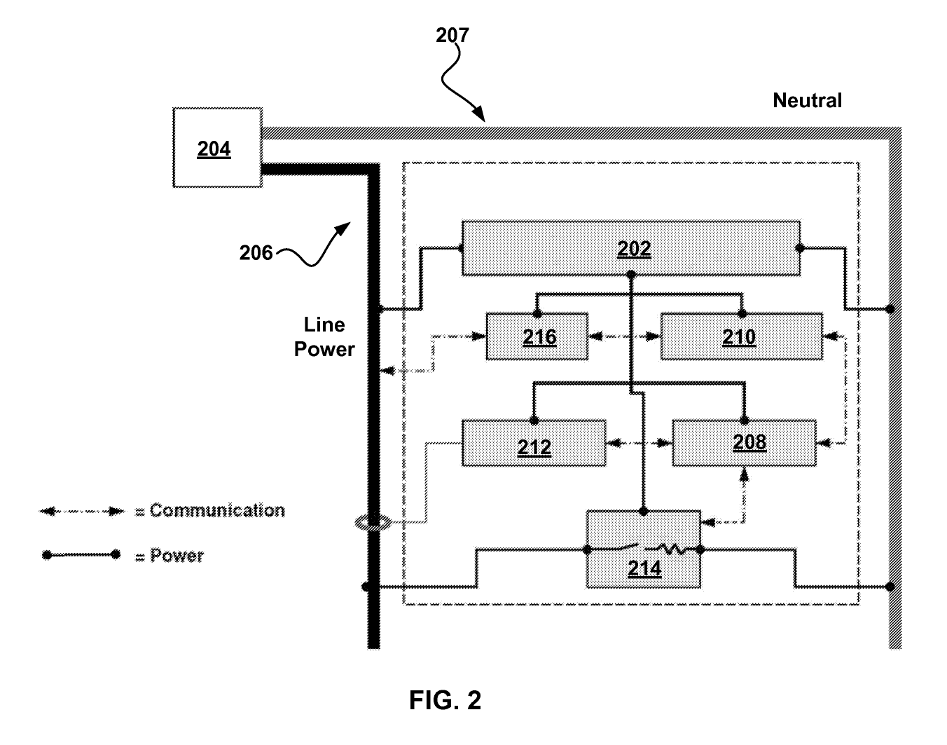

The control circuitry or node electronics may be utilized to provide signals to other nodes or to a central processor, sense power usage by the node, and other functions. FIG. 2 is a block diagram of an exemplary version of the electronics associated with a node. The unit may include a power supply 202, a microcontroller 208, a communications function 210, a power measurement function 212, a switchable micro-load 214 and a coupler 216, which enables communication to take place on the power lines.

The power supply may draw power from a power source 204 though power line 206 with a return path for the current, neutral line 207. The power supply may be a low voltage power supply (e.g. less than 30 volts), and may be configured to transform the power from AC to DC, and reduce the voltage to a level acceptable for the micro-controller, the switchable micro-load and communication functions. In addition, the power supply may include a battery, which may be charged with energy available between line power 206 and neutral 207. A micro-controller is illustrated at 208 for controlling the actions of the unit based on logic inputs. The micro-controller may also include arithmetic elements, as well as volatile and/or non-volatile memory. In addition, the micro-controller may include identifier information for identifying the node, such as a serial number stored in the controller.

A communications function 210 may also be provided. The communication function may be provided on the micro-controller as input and output interfaces. The communication function may create and receive node electronic signals which may be interpreted by the various electronics within the node, other nodes or in a central processor with which the node may communicate. Signals received by the node may be filtered from and to the power line by a coupler 216. The coupler 216 may allow for one or more communication signals to be sent over the power line 206 and may utilize existing communication standards.

A power measurement function 212 which may measure key aspects of power (current, voltage, phase . . . etc.), may also be integrated into the micro-controller, or communicate therewith. The power measurement function may be facilitated by measuring the magnetic field generated by the current and/or the voltage across the node. While it may be appreciated that power may not be measured directly, power may be determined by measurement of both current and voltage. Sensors for performing these functions, e.g., measuring current, phase or voltage, may include Hall effect sensors, current transformers, Rogowski coils, as well as other devices.

A switchable “micro-load” 214 may also be included. The switchable “micro-load” may create a directional and detectable electrical event. The micro-load may be activated when directed by the microcontroller, such as during mapping or other system functions. The powered micro-controller may direct the switchable micro-load to trigger, creating a detectable signal for upstream nodes i.e. those nodes required to transmit power from the source.

In addition to the above, the node electronics may also include a number of other functions. For example, the electronics may include a temperature sensor (or other environmental sensors). Furthermore, the electronics may also provide user-detectable signals, such as audio or optical signals for alerting a user to the physical location of the node.

The node may also include a means for a user to convey information to it, for example a button. When said button is operated by a user it may cause a communication to be sent identifying the node to which this operation occurred. This may provide another means of correlating a node's physical location with respect to an electronic representation of the system wiring.

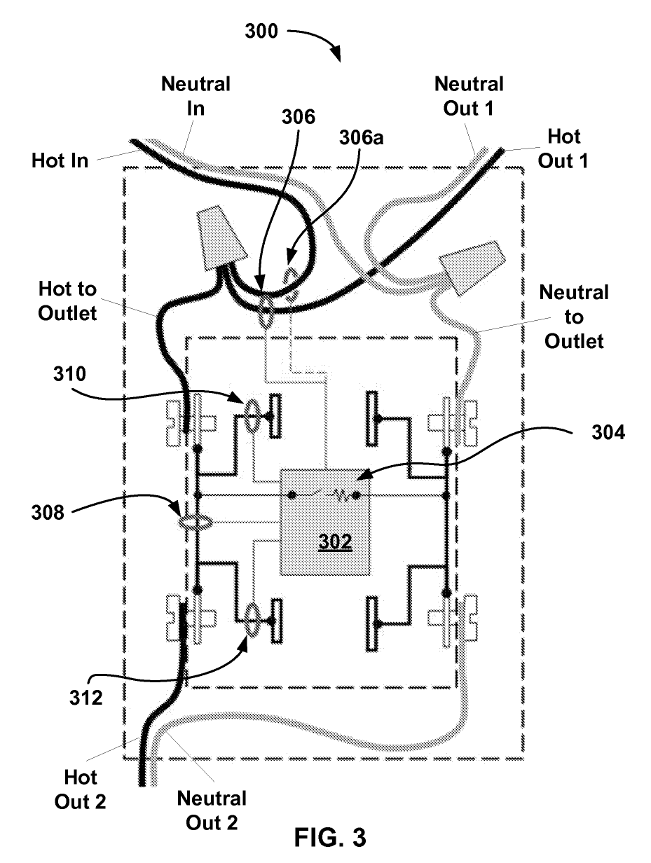

The node wiring and electronics may be configured based on the node type. For example, FIG. 3 is a diagram of an exemplary outlet node 300 (which represents a duplex socket) and associated wiring. The outlet may include power provided through a “hot wire” via the “Hot In” wire and to the individual sockets via wire “Hot to Oulet.” Power may also pass through the outlet via “Hot Out 1” and “Hot Out 2.” In addition, a neutral may be provided to the outlet “Neutral In” as well as through the outlet and out of the outlet, “Neutral Out 1” and “Neutral Out 2,” respectively. The electronics 302 may include a switchable micro-load 304. Current sensor 308 may enable measurement of the power flowing through the node, a feature which may enable mapping, and current sensors 310 and 312, may measure power drawn from their respective sockets. In addition, external current sensors, 306 and 306a, may be provided, either of which may monitor power passing through the electrical box that does not pass through the node itself. Accordingly, it may be appreciated that the current passing through the node, being drawn from the node and flowing around the node may all be measured. These sensors may allow for a better understanding of the physical location of nodes with respect to one another. In situations where the two sockets of a duplex receptacle are wired separately, a single set of node electronics may be used for both monitoring and mapping each receptacle independently.

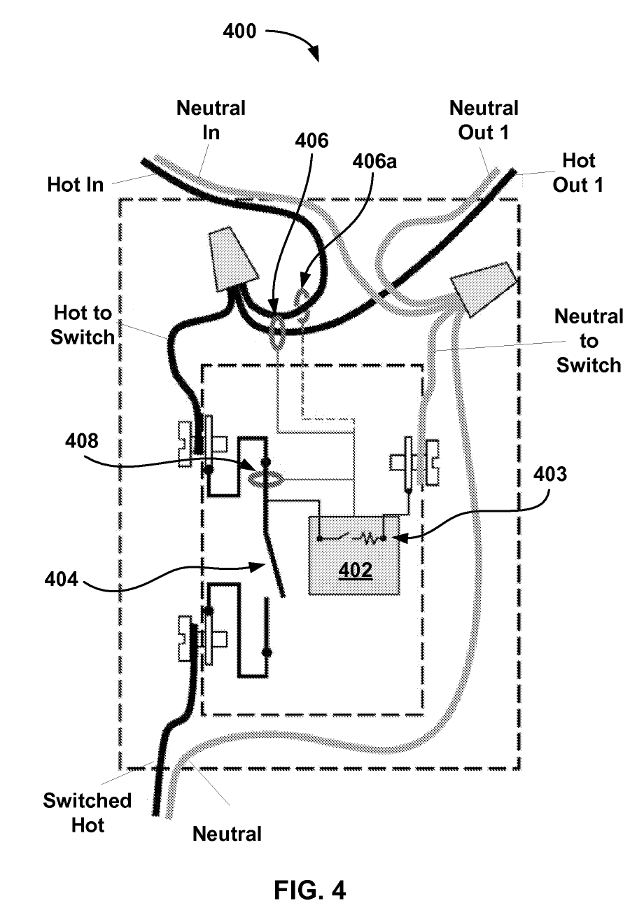

FIG. 4 is a diagram of an exemplary 2-way switch node 400 and its associated wiring, i.e., “Hot In,” “Hot Out,” “Hot to Switch,” “Switched Hot,” as well as “Neutral In,” “Neutral Out,” “Neutral to Switch,” etc. As seen, the electronics 402 may include a switchable micro-load 403 for the switch 404. Current sensor 408 may enable measurement of the power drawn through the switch. The electronics may also include external sensors 406 and 406a, which may monitor power which runs through the electrical box, but not the node, allowing for a better understanding of the physical location of nodes with respect to one another. Note that the switch may include a neutral connection, which allows the system electronics to be powered for its various activities. Other schemes for drawing power without the neutral connection are contemplated. For example a current transformer may be used, which may pull power from a single wire when the switch is closed and under load. This power may be used to drive the node electronics and/or recharge a battery to power the node electronics for periods when power is not flowing. In addition, a small amount of power may be drawn from line voltage and returned to ground, in such a fashion and amount that it does not present any danger to people or property (and also so that any GFI in the circuit does not unintentionally trip). This configuration may be used to charge a battery, which in turn may drive the electronics.

In another example, power may be drawn in series with the load, allowing a relatively small current to flow through the node when it is notionally off, in a configuration similar to existing lighted switches. Power drawn by this method might be used to power the node electronics and/or charge a battery to power the node electronics in conditions that do not allow for power to be provided.

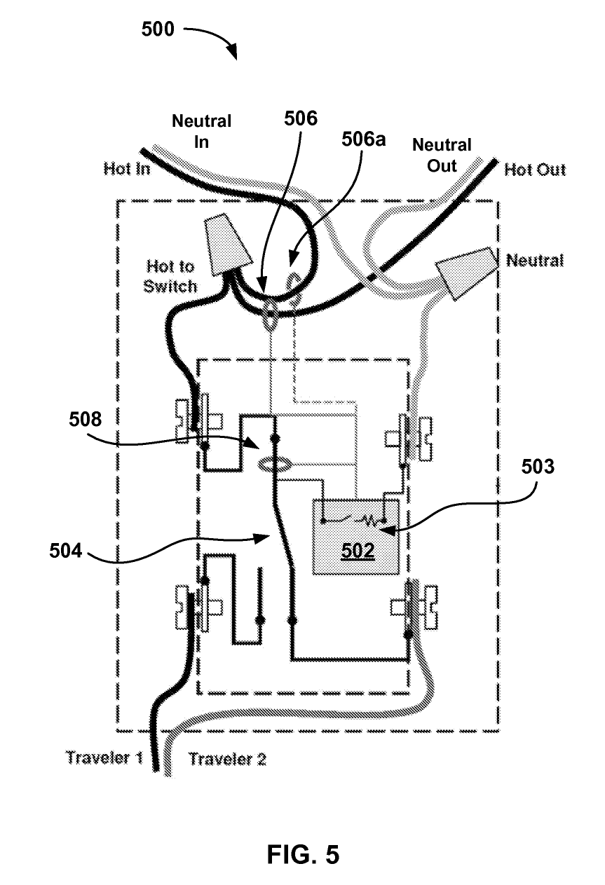

FIG. 5 is a diagram of an exemplary 3-way switch, wherein some of the characteristics are consistent to those described with respect to FIG. 4. More specifically, the electronics 502 may include a switchable micro-load 503 for the switch. Current sensor 508 may measure the power drawn from the switch. The electronics may also include external sensors 506 and 506a for monitoring power which runs through the box but not the node, allowing for a better understanding of the physical location of nodes with respect to one another. Once again, the switch may include a neutral connection, which may allow the system electronics to be powered for its various activities. Similar methods for powering a 2-way switch in the absence of a neutral may also be applied for a 3-way switch.

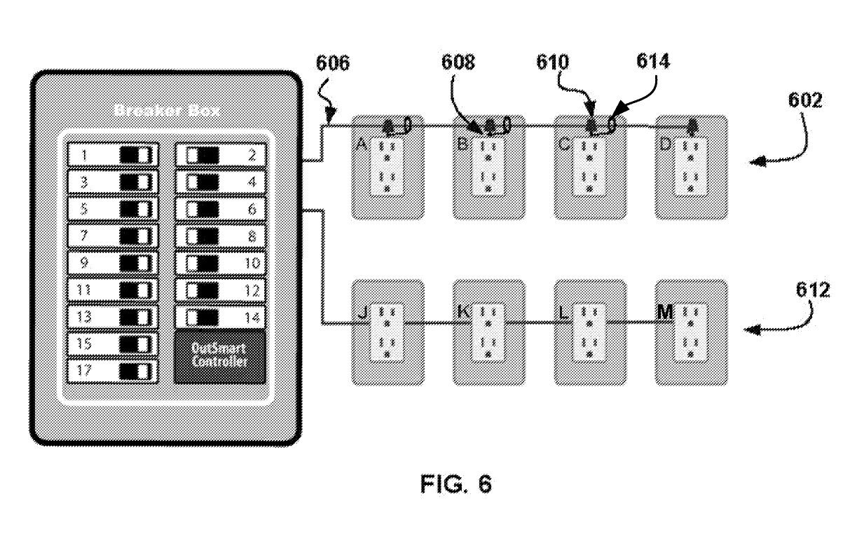

FIG. 6 shows the difference between what is termed a “pig-tail” (or parallel) configuration 602, and a “through” or series configuration 612. In a “pig-tail” configuration power may be brought into an electrical or junction box A-D from a main line 606 and a short wire 608 is connected to the incoming wire and the outgoing wire (through wire nut 610, for example) to power a nodes A-D. This means that if any outlet/node is disconnected, power may continue to be provided to other nodes. This may be in contrast to through wiring 612, where a conductive pathway within node J may be responsible for powering subsequent nodes K, L and M, (i.e. disconnecting power to node J will remove power from nodes K, L and M). In the pigtail configuration, external sensors (e.g. 614) may be employed, which may indicate that A was wired before B, which was before C, which was before D. It should therefore be understood herein that node A is considered to be electrically upstream of, for example nodes B, C and D. For outlets J through K, the current sensor within the node may determine the order of the outlets relative to one another. Electrical junction boxes may also be configured with suitable electronics, so the monitoring and mapping information may be done by the box, which would then effectively be a node.

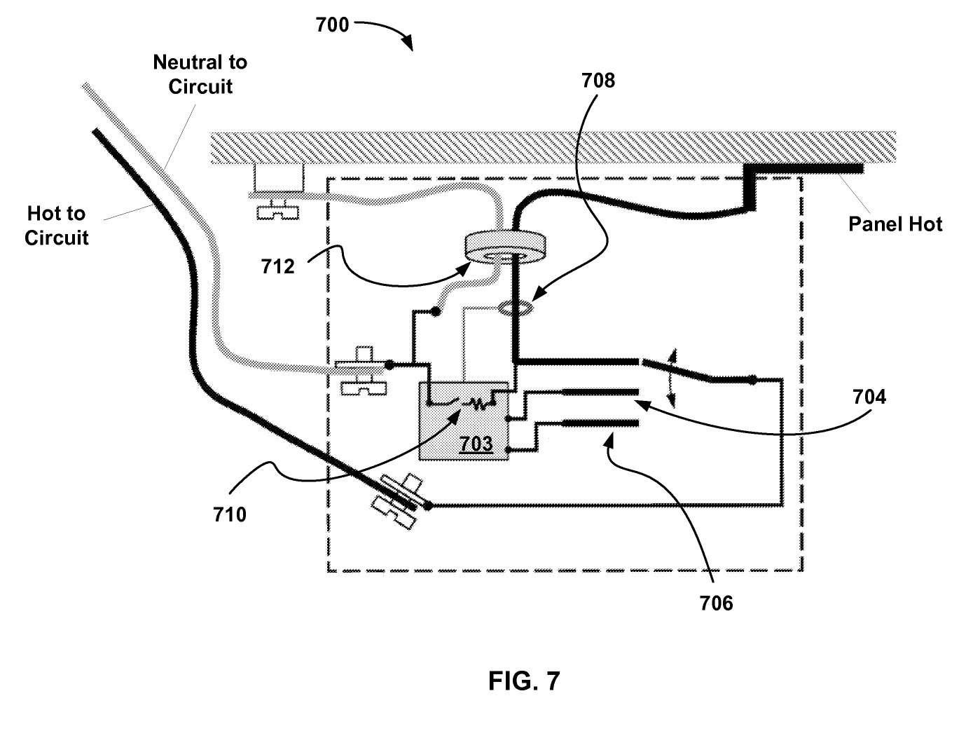

FIG. 7 is a diagram of an exemplary circuit breaker including system electronics 703. The breaker may receive power from the circuit panel through a “hot” wire “Panel Hot.” The breaker may provide power to a circuit “Hot to Circuit” and a neutral “Neutral to Circuit.” Like other nodes, it may apply a switchable load 710 which may allow itself to be identified in the network. The circuit breaker node may also include a sensor 708 to enable power measurement through the breaker. Like other breakers, it may have the ability to switch off in the case of an over-current, ground fault and/or arc-fault condition or other conditions which may be deemed unsafe. For example, the breaker may include a GFI sensor and/or other electronics 712. However, when the breaker trips and removes power, it may continue to provide communication with its circuit and the rest of the system. The individual nodes on the circuit may be self-powered including batteries, capacitor or super-capacitor, etc., so that they may communicate information to the breaker during a fault condition. The circuit may then report to the breaker and then to the processor (central or distributed) what may have caused the fault and what actions should be taken before turning the circuit back on. Among many possibilities, these actions may include unplugging a load (appliance) or calling an electrician.

In one embodiment, the breaker may switch to a communications channel 704 where nodes, running on residual power (provided by a battery or capacitor, etc.) may communicate their status. In another exemplary embodiment, the breaker may connect to a power limited channel 706 (low voltage and/or current) to continue to provide small amounts of power to the circuit for communication. This power could be applied as a low voltage supply between line and neutral or a low voltage supply between line and ground, at a level that does not present a danger, and assuring the power draw does not cause any GFI in the circuit to trip. The breaker may be configured to enter either a communications or low power mode via a remote command to interrogate the system and identify problems. Alternatively, the nodes may be able to communicate important information about the events leading to a fault condition before the breaker trips.

It may be appreciated from the above, that also contemplated herein is a mechanism for nodes to communicate their state to the system. State may be understood as the current condition of a node and/or its adjustable parameters, e.g. whether a switch is on or off, whether power is being drawn from the node and in some cases, the extent of the power being drawn from the node. For instance, if a light switch, such as those referred to in FIGS. 4 and 5 did not have a neutral connection, but was powered through some other device (e.g. inductive or battery), when turned on it would announce itself to the system and its state (of being on) and the system could detect that a load appeared through the switch and other upstream nodes, thereby establishing the switch's position in the network. Effectively, the load may serve as the detectable directional event for the switch. Additionally, if a switch is turned on and communicates its state to the system, and no load or outlet is seen beyond the switch, one may construe some type of problem—e.g. a bulb has failed. Similarly, if the load associated with a switch changes over time, one or more of many light bulbs may have failed. A controlled or switchable outlet, could function in much the same manner described, communicating its state to the system. A dimmer switch, for example, could communicate the level at which it has been set.

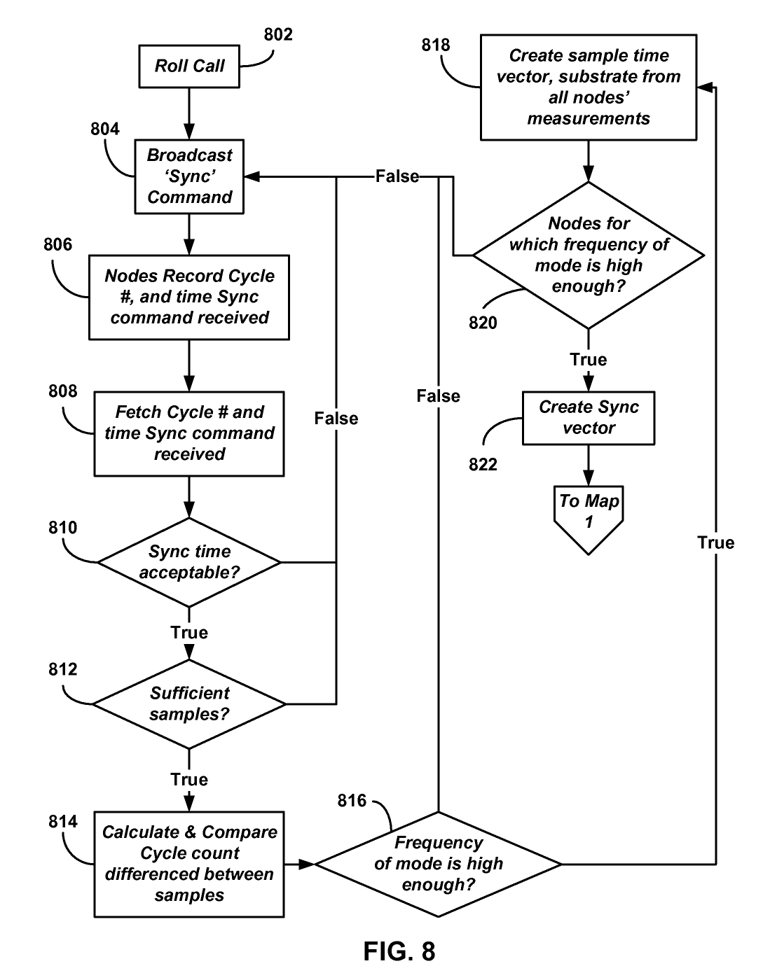

As alluded to above and also contemplated herein is a method for mapping the various nodes and monitoring power usage and other information via communication between the nodes and the processor. The process of mapping the nodes may begin with the individual nodes or the central processor. For example, when a node is powered or reset, or the central processor sends a reset signal as illustrated in FIG. 8 a roll call may be initiated at 802. Each active node may wait a random period of time and send a message to the processor indicating that it is present. An active node may be understood as a node currently capable of communicating with a processor. Inactive nodes may be understood as nodes currently unable to communicate with a processor (e.g. because they are isolated by a switch which is turned off or are powered only in the presence of a load . . . etc.) and may or may not be accounted for by the processor, depending on whether the node was (previously known to exist and deemed) likely to reappear at some later point in time. When each active node sends a message to the processor that it is present, the message may include descriptive information, such as, identifying information, e.g., a serial number, or the type of node it may be, e.g., switch, breaker, outlet, appliance, etc. The processor may create a list of all the active nodes present on the network at that time, including any descriptive information sent to the processor. In addition, the nodes may include a line cycle counter that may be started when the node is powered up or reset.

Once the system is aware of the active nodes which may be present in the system, the system may synchronize the nodes. The processor may broadcast a ‘Sync’ command to all nodes at 804. In one exemplary embodiment, each node may maintain a line cycle counter, which may increment on the positive going zero crossing of the line voltage waveform. Upon receipt of the sync command, the node may save a copy of the counter as C, and the time since the last increment, i.e., on the last or previous positive going rising edge of the line voltage wave form as R at 806. The node may then provide the values of C and R to the processor upon request, such as a Fetch Cycle at 808. If R is reported as being too close to the zero crossing time for a significant number of nodes, then sync times may be found to be unacceptable and the set of measurements may be rejected at 810.

The ‘Sync” operation may be performed a number of times until sufficient samples are collected, as decided at 812. For a given number of nodes n and a given number of samples q, the values of C collected may be saved as an array according to the following:

C[m][p],

wherein m is an index of the node (from 1 to n), and p is an index of the sample set (from 1 to q). It may be appreciated that the data might contain some errors. The following table includes an exemplary dataset for purposes of illustration, wherein n=5 and q=6, as follows:

| | |
|---|---|
| C[m][p] | Time Sample p |

| Node m | 1 | 2 | 3 | 4 | 5 | 6 |
|---|---|---|---|---|---|---|
| 1 | 773 | 1157 | 1260 | 1507 | 1755 | 1846 |
| 2 | 719 | 1102 | 1205 | 1452 | 1699 | 1791 |
| 3 | 773 | 1157 | 1259 | 1507 | 1754 | 1846 |
| 4 | 598 | 984 | 1085 | 1332 | 1579 | 1671 |
| 5 | 530 | 914 | 1017 | 1263 | 1511 | 1602 |

From the array, a set of differences may be calculated at 814 according to the following equation:

ΔC[m][p]=C[m][p]−C[m][p−1]

For example, based upon the same data the following results may be obtained:

| ΔC[m][p] | Time Sample differences p | | | | |
|---|---|---|---|---|---|
| Node m | 2-1 | 3-2 | 4-3 | 5-4 | 6-5 |
| 1 | 384 | 103 | 247 | 248 | 91 |
| 2 | 383 | 103 | 247 | 247 | 92 |
| 3 | 384 | 102 | 248 | 247 | 92 |
| 4 | 386 | 101 | 247 | 247 | 92 |
| 5 | 384 | 103 | 246 | 248 | 91 |

The mode (most common value) for all m may then be calculated at 816 for each value of p according to the following equation:

ΔT[p]=mode of ΔC[m][p]

across all values of m, for each value of p. For example, based upon the same data, the following may be observed:

| | Time Sample difference p | | | | |
|---|---|---|---|---|---|
| ΔT[p] | 2-1 | 3-2 | 4-3 | 5-4 | 6-5 |
| Sample | 384 | 103 | 247 | 247 | 92 |
| Vector | | | | | |

The series may be summed, where T[1] may be assumed to be 0, using the following equation:

T[p]=ΔT[p]+T[p−1] for p from 2 to q.

For example, based upon the same data:

Time Sample p

| T[p] | 1 | 2 | 3 | 4 | 5 | 6 |
|---|---|---|---|---|---|---|
| Vector | 0 | 384 | 487 | 734 | 981 | 1073 |

If the mode does not represent a large enough proportion of the nodes at 816 for any sample then the sample may be rejected from T and a more sync commands may be sent. Where the mode represents a sufficient portion of the nodes at 816, another set of differences may be calculated at 818, wherein

ΔD[m][p]=C[m][p]−T[p].

For example, based upon the same data:

| | |
|---|---|
| ΔD[m][p] | Time Sample p |

| Node m | 1 | 2 | 3 | 4 | 5 | 6 |
|---|---|---|---|---|---|---|
| 1 | 773 | 773 | 773 | 773 | 774 | 773 |
| 2 | 719 | 718 | 718 | 718 | 718 | 718 |
| 3 | 773 | 773 | 772 | 773 | 773 | 773 |
| 4 | 598 | 598 | 598 | 598 | 598 | 598 |
| 5 | 530 | 530 | 530 | 529 | 530 | 529 |

The mode for all p may be calculated at 820 from each value of m, according to the following equation:

D[m]=mode of ΔD[m][p]

across all values of p, for each value of m, wherein D[m] represents the relative cycle value for the nodes internal line cycle counters. For example, based upon the same data:

| D [m] | |
|---|---|
| Node m | Sync Vector |
| 1 | 773 |
| 2 | 718 |
| 3 | 773 |
| 4 | 598 |
| 5 | 530 |

Showing that, for example, for node 1, line cycle 773 refers to the same interval of time as line cycle 530 for node 5.

If the mode for any node did not represent a large enough proportion of the samples at 820, then the node may still be considered unsynchronized, and the operation may be repeated to synchronize any such nodes to the other already synchronized nodes. If the mode did represent a large enough portion of the samples at 820, then as above, a table of sync offsets may be generated for each node at 822. It may be appreciated that in repeating the procedure, a synchronized node does not become an unsynchronized node.

After the system is synchronized, the process of mapping the nodes relative to one another can take place. The first practical step in mapping the electrical network is to assign nodes to breakers. Although it is feasible to map the network without using this approach, assigning nodes to breakers first may be more efficient.

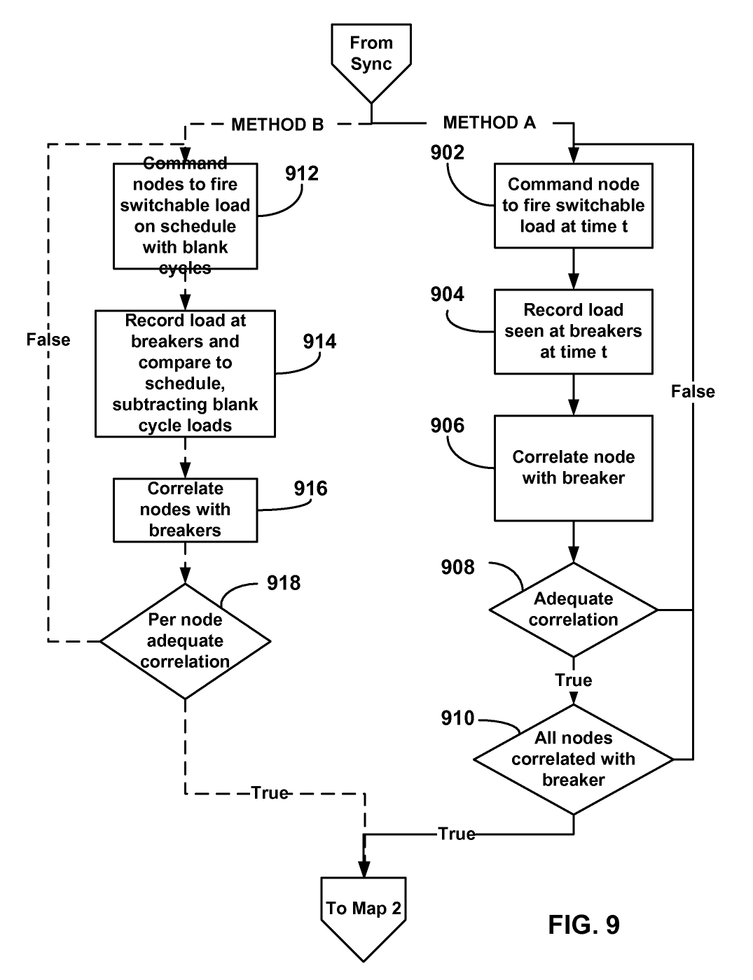

A first exemplary process of assigning individual nodes to breakers can be done on a node by node basis is illustrated in FIG. 9 as “Method A”. A node may be given a command to trigger its switchable load at a known time at 902. Each breaker monitors the power flowing through it at this time at 904. The node may then be assigned to any breaker which observed the power flow caused by a node's switchable load at this time at 906.

A second method, illustrated in FIG. 9 as “Method B” may include commanding all nodes to trigger their switchable load on a predetermined schedule, allowing blank cycles to precede and follow each switchable load event at 912. The blank cycles between switchable load events may desensitize the mapping process to other loads which may be present. Loads seen during the blank cycles (or an average of this load during the blank cycle immediately preceding and following a switchable load event) may be subtracted to better detect the switchable load power draw at 914. For the duration of the schedule, all breakers are commanded to monitor power flow. After the schedule is complete, information is gathered by the processor to determine which nodes should be assigned to which breakers at 916.

For example individual nodes may be assigned to breakers according to the following methodology. For a given number of nodes n, and assuming that a micro-load uses energy “e” in one line cycle, all of the breakers may be commanded to measure energy flow on a line cycle by line cycle basis for 2n+1 line cycles, from line cycle a to line cycle a+2n inclusive. All nodes may be commanded to fire their micro-loads at 912 on different line cycles, node 1 on line cycle a+1, node 2 on a+3, node 3 on a+5 and so on to node n on a+2n−1. Upon completion, the energy measurements may be retrieved from the breakers by the processor at 914 and then the nodes may be correlated with the breakers at 916. The energy flow in time cycle a+t in breaker b may be designated E[b][t].

The magnitude of difference in energy flow between a line cycle where a given node p's micro-load was fired, and the average of the adjacent cycles where no micro-load was fired, may then be calculated according to the following equation:

D[b][p]=═E[b][2p−1]−0.5*(E[b][2p−2]+E[b][2p]═

If, for example, the threshold for determining whether the switchable load observed was 80% of the expected value, then if D[b][p]<0.2e then node p may not be present in breaker b's circuit. Otherwise if 0.8e<D[b][p]<1.2e then node p may be present in breaker b's circuit. If the conditions are not met at 918, the measurement may be considered indeterminate and may be repeated. It may be appreciated that once all of the measurements and calculations are complete each node may be present under one and only one breaker's circuit (with the exception of breakers wired ‘downstream’ of other breakers) at 918.

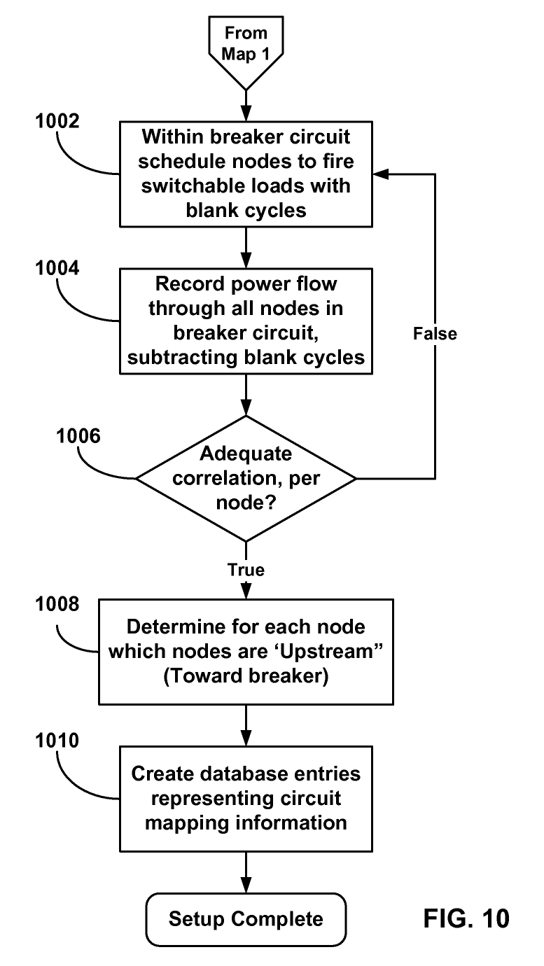

After the nodes have been assigned to a breaker, the next logical step is to map the nodes within the breaker circuits, as illustrated in FIG. 10. The method may include commanding all nodes within the breaker circuit to trigger their switchable load on a predetermined schedule, allowing blank cycles to precede and follow each switchable load event. The blank cycles between switchable load events, as before, may desensitize the mapping process to other loads which may be present. Loads seen during the blank cycles (or an average of this load during the blank cycle immediately preceding and following a switchable load event) may be subtracted to better detect the switchable load power draw. For the duration of the schedule, all nodes within the breaker circuit may be commanded to monitor power flow. After the schedule is complete, information may be gathered by the processor to determine which nodes observe the switchable load of each other nodes, and are therefore deemed “upstream” of them, and thereby determine the circuit topology.

For example, mapping nodes within the breaker circuit may include the following. For a given number of nodes n in a sub-circuit to be mapped, and assuming that a micro-load uses energy e in one line cycle, all of the nodes may be set up to measure through energy flow on a line cycle by line cycle basis for 2n+1 line cycles, from line cycle a to line cycle a+2n inclusive. All nodes may be set to fire their micro-loads at 1002 on different line cycles, node 1 on line cycle a+1, node 2 on a+3, node 3 on a+5 and so on to node n on a+2n−1. The power flow through all the nodes in the breaker circuit may be recorded and upon completion of the measurements the energy measurements may be retrieved from the nodes by the processor at 1004. The measurements from blank cycles may be subtracted from those when loads were expected, as well. The energy flow in time cycle a+t through a node b is designated E[b][t].

The magnitude of difference in energy flow between a line cycle where a given node p's micro-load was fired, and the average of the adjacent cycles where no micro-load was fired, may then be calculated using the following equation.

D[b][p]=═E[b][2p−1]−0.5*(E[b][2p−2]+E[b][2p]═

If, for example, the threshold for determining whether the switchable load observed was 80% of the expected value, then if D[b][p]<0.2e then node p may not be downstream of node b. Otherwise if 0.8e<D[b][p]<1.2e then node p may be downstream of node b. If these conditions are not met, the measurement may be considered indeterminate and may be repeated at 1006.

A determination may then be made as to which nodes may be “upstream” or “downstream” relative to one another at 1008. Once all of the measurements and calculations are completed each node may have a subset of nodes for which it detected the presence of the switchable load, i.e., nodes which are “downstream” of it. A node may be determined to be “downstream” of itself or not depending upon the direction in which it is wired; this may be used to determine wiring orientation of a given node (e.g. whether the line in power is coming in at bottom lug of an outlet or the top lug). Any node “downstream” of no nodes other than the breaker node, may be directly connected to the breaker, with no intervening nodes. In addition, any node detected by such a node and the breaker only may be directly ‘downstream’ of such detecting node. This process may be iterated until all of the nodes may be accounted for, and hence mapped. Furthermore, in order to represent the circuit topology in the database, the record for each node may contain a pointer to the node immediately ‘upstream’ of it. Accordingly a database of entries representing circuit mapping information may be created at 1010.

If a particular node is not powered because of a switch in the off condition, it may not be initially mapped. However, once power is enabled to those nodes, they may make themselves known to the network via the processor (such as central computer 102 of FIG. 1) which may then call for the newly found node or nodes to be synchronized and mapped in a similar manner to the previously described synchronization and mapping methods.

A user may interact with the system through a system interface. Referring back to FIG. 1, a system interface may be present at the central processor 102 or may be integrated as a display panel 112 in or proximate to the breaker panel 104 itself, or anywhere else in communication with the nodes. Furthermore, multiple system interfaces may be provided or may interact with the system. For example, in addition to or instead of a display mounted on the power distribution center or central computer as illustrated in FIG. 1, information may be sent to the internet, over the powerline, or wirelessly over a router to a remote device, or may be sent over a network to a phone, etc.

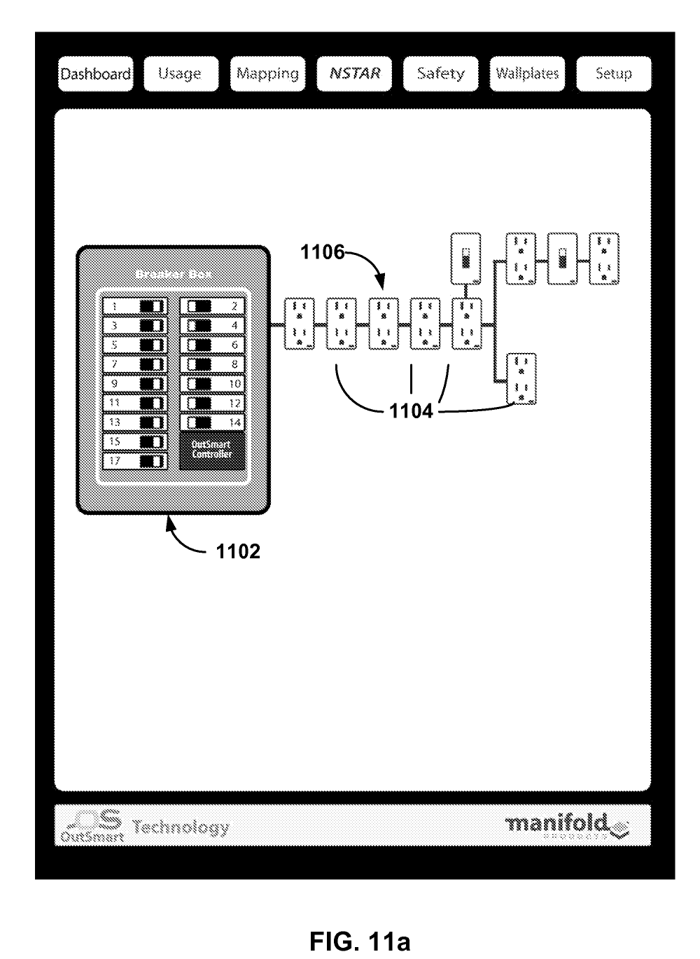

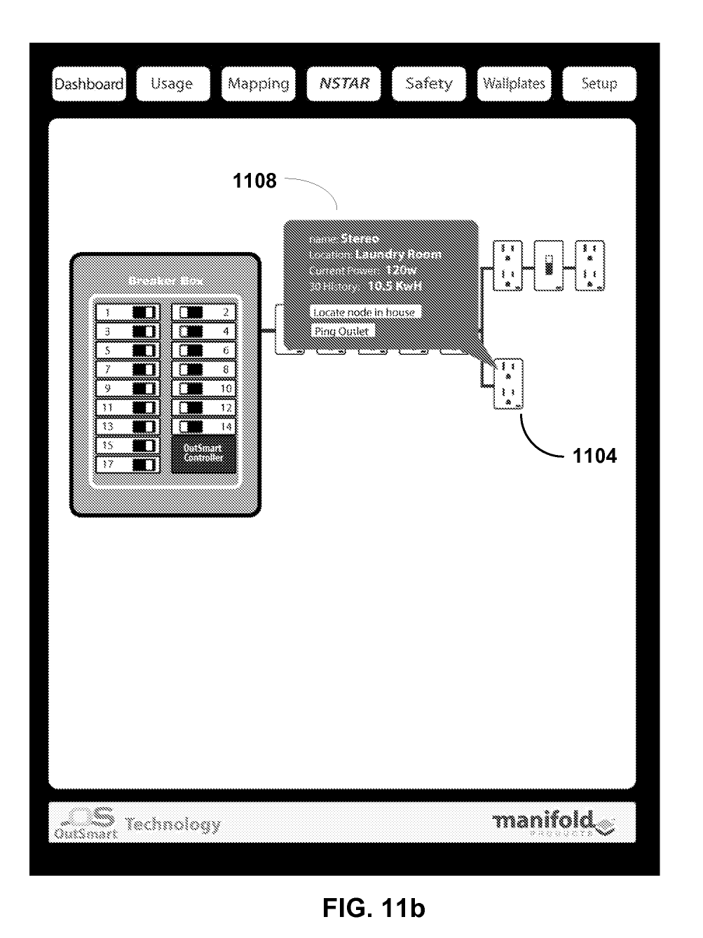

The interface may generally include a display and a mechanism for interacting with the system, such as a touch screen display, a mouse, keyboard, etc. As illustrated in FIG. 11a, the display may include a representation of the breaker box 1102 and the nodes 1104 mapped to a selected circuit 1106. By selecting a given node 1104 in the circuit 1106, as illustrated in FIG. 11b information 1108 may be displayed as to what may be plugged into the node, the current power usage of the node and the power used by the node over a given time period. It should be appreciated that other or additional information may be displayed as well.

The system may also allow for monitoring the power used at each node and, in fact, the power used at each outlet receptacle (top and bottom), as well as many other items (for instance, temperature, other environmental conditions, exact current draw profile . . . etc). In one example, data may be received by a processor that is indicative of power consumed or a load over a given period of time attached to one or more of the nodes. From this data a power consumption profile for each node, as well as collective nodes (e.g., nodes of a given room or nodes of a given circuit) may be generated. While such a profile may consider power consumed over a period of time, including seconds, minutes, hours, days, weeks, months or years, the profile may also consider other variables, such as power usage, current draw, power factor, duty cycle, start up current, shut down current, standby power, line voltage, current wave form, time of day, date, location and/or environmental conditions or cross correlations thereof. Furthermore, data regarding power cost may be utilized to develop cost profiles. A cross-correlation may be understood as the measurement of a similarity across two or more datasets. For example, power consumption and ambient temperature, lighting loads and time of day, start-up current and temperature, etc.

Where deviations of a predetermined amount from the profile are detected, an alert may be provided, power to the node may be cut, or an associated breaker may be tripped. The predetermined amount may be based on the overall profile or given segments of a profile related to time of day, or may be device specific. In addition, the predetermined amount may be based on cost, where energy pricing may be higher during a given time of the day.

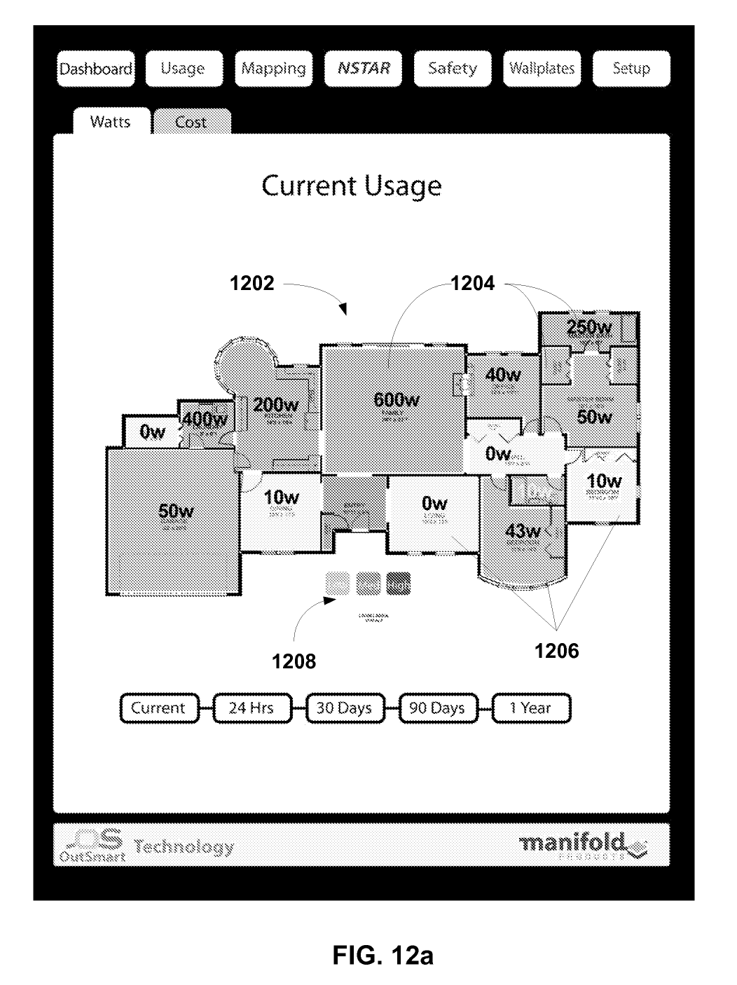

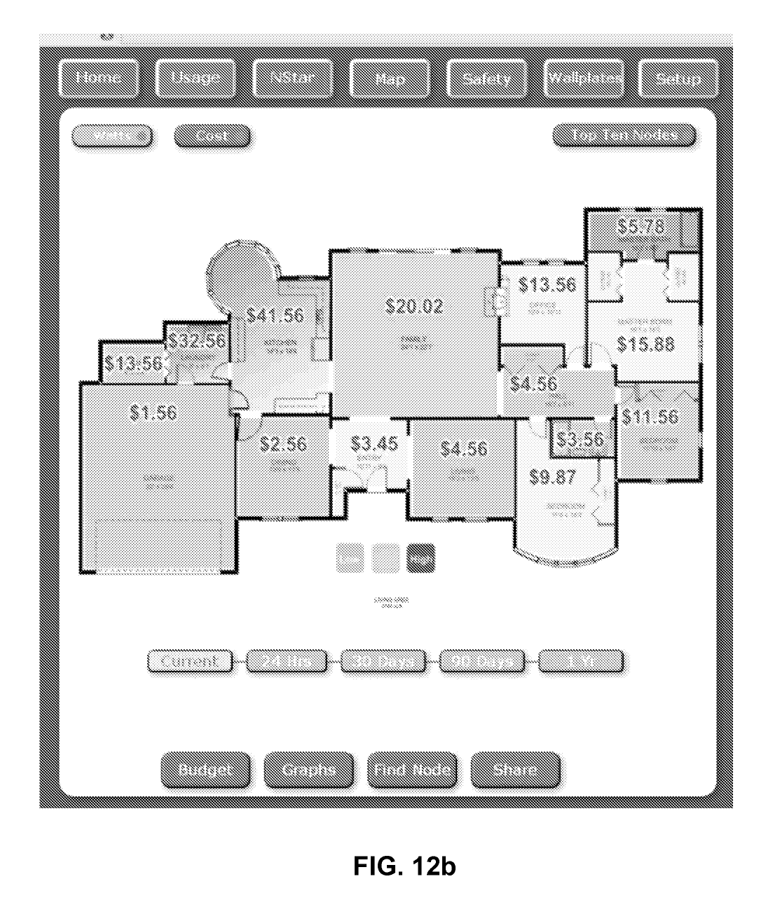

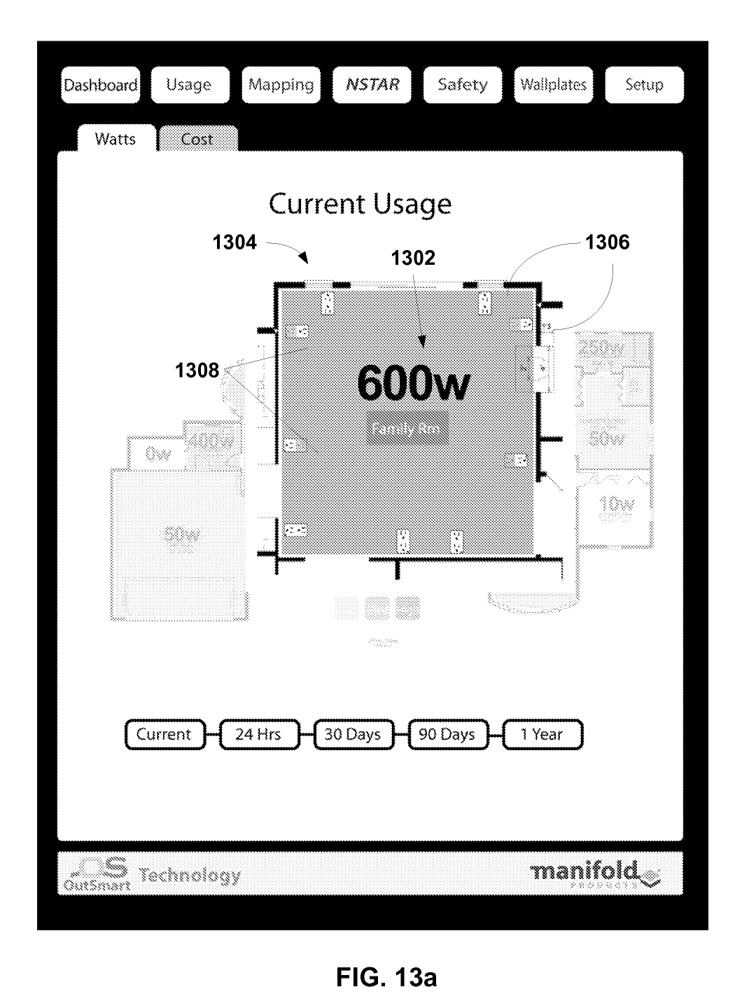

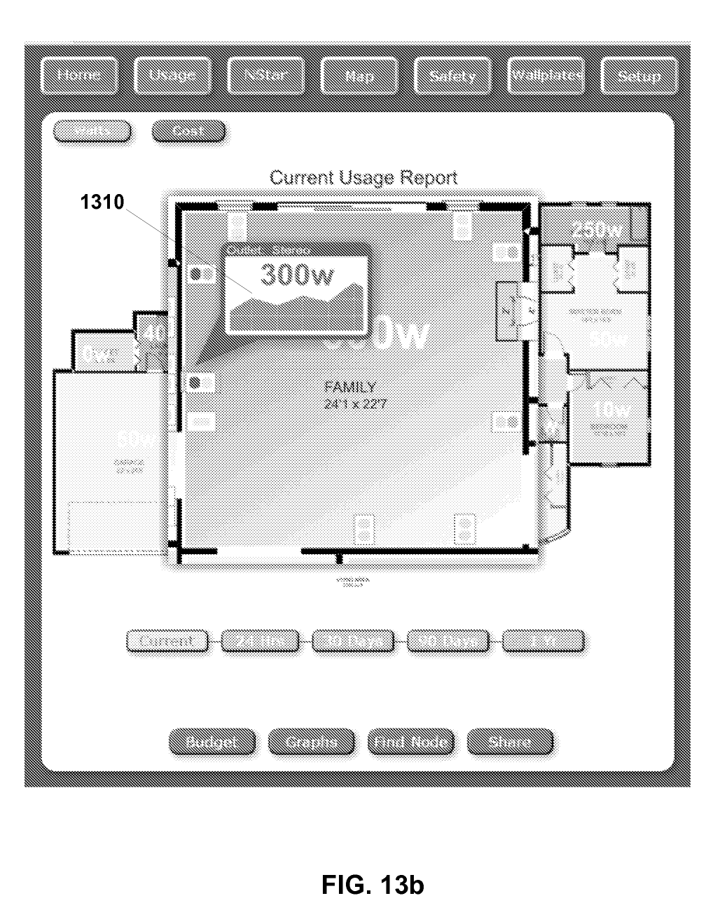

FIG. 12a is an illustration of how such data may be displayed to a user. For example the nodes may be associated with given rooms in a building, and determinations may be made as to the power usage of the various rooms, which may be broken down in a variety of units, such as Watts as illustrated in FIG. 12a, Watt-hours or monetary units as illustrated in FIG. 12b. The building 1202, rooms 1204 and power usage in each room 1206 may be displayed to a user. For reference purposes the usage may be quantified in terms of a color scale 1208. In addition, a representation of a specific room may be created, as illustrated in FIG. 13a, wherein information such as the power usage 1302 for the room 1304, node location 1306 or active nodes 1308 may be provided. Analysis of specific nodes may also be made, as illustrated in FIG. 13b, wherein usage at a given node may be determined, profiled 1310 or otherwise analyzed.

As may be appreciated from the above illustrations, the system may allow for the physical location of nodes to be correlated to a virtual diagram and the electrical location of a node within a wiring diagram may be correlated to the location of the physical (real) node. This may require a means of user input to the physical node, for example a button may be provided on the front of each node, and/or an audio, optical or other signal may also be provided which may be detectable by a user as to the location of a particular node.

Another aspect of the present disclosure relates to monitoring the safety of a network by evaluating and monitoring the status of the nodes, including the power flowing through and from the nodes. In a powered network of wires and devices, unsafe conditions may exist when power is used or “lost” in unintended ways. Some of these ways include arcs (either series or parallel) and high resistances (due to bad connections or wires). The present disclosure includes a means for summing the power of a network at, from and through the nodes, and is capable of identifying “lost” power. The present disclosure is of a system which not only identifies lost power, but identifies between which nodes the power was lost, providing information for the purpose of identifying, troubleshooting and ultimately, fixing a particular problem.

In one example, one or more nodes connected to an upstream node may be identified. Once identified, a difference in the power transmitted from and through the downstream node(s) and the power transmitted by the upstream node may be determined. If the power transmitted by the upstream node is greater than the measured power drawn from or through the node network, an alert may be provided and/or a breaker may be tripped.

Referring to FIG. 1 as an example, breaker node 9 transmits power to nodes P and Q. In order to evaluate the potential for any lost power in this circuit, the system first identifies nodes in a circuit for which there are no other downstream nodes. In this example, node Q is the only node that satisfies this condition. (In the case of breaker 2's circuit, nodes D, H, G and I all satisfy this condition.) The circuit is first evaluated by looking at the point just downstream of the next upstream node (P). The power transmitted through this point in the network (i.e. the power transmitted to node Q by node P) should equal the power drawn from the receptacles at node Q. If this is not the case, unintended power may have been lost between nodes P and Q through an arc, high resistance or other situation. Then, evaluating the point just downstream of the next upstream node (in this case, breaker 9), the power transmitted by breaker node 9 should equal the power drawn from node P's receptacles and the power transmitted by node P to node Q. Consequently, in a safe condition, the power transmitted by breaker node 9 should equal the sum of the power drawn from node P (through its receptacles) and the power transmitted from node P to node Q. If this is not the case, unintended power may have been lost in the segment of the network between the breaker node 9 and node P. As an extension of this logic, power transmitted through breaker node 9 should equal the combined power drawn from nodes P and Q (through their respective receptacles).

In this fashion a complex network of nodes can be analyzed segment by segment. Alerts as described above may be fed to an interface, where a user may then diagnose the problem or may be provided with helpful hints on solving the problem. It may be appreciated that a plurality of nodes may be identified as being associated with the breaker and the power consumption for each of the nodes may be identified. Accordingly, if one of a plurality of nodes is “losing” power or the network between two nodes is losing power, that portion of the network may be identified and the problem remedied.

As an example of the above, if one of the wires powering node Q were loose, it may cause a voltage drop as a result of current being drawn from one of the outlets of node Q through the resistance of the poor connection. If no power is being drawn from node Q, no power will be transmitted from node P, and the condition will be deemed safe. A load drawing 1 kW may then be placed on an outlet from node Q, node Q will report power delivered from node Q as 1 kW, but node P may report a transmitted power in the direction of node Q as 1.1 kW. Therefore, 100 W is unaccounted for, and is being dissipated in the system. In fact, the lost 100 W is being dissipated in the loose connection. The calculations performed would identify that 100 W was lost after node P, and before node Q. This condition may be deemed unsafe and the breaker may be tripped. In another example a mouse may chew the wiring between nodes P and Q, resulting in a fault current from hot and neutral in wire. Node P may report a power transmitted in the direction of node Q of 50 W, but node Q would report no loads, in fact the 50 W is being dissipated in the mouse. The calculations performed would identify that 50 W was lost after node P, and before node Q. This condition may be deemed unsafe and the breaker may be tripped. The system is capable of distinguishing between these two conditions by measuring the voltages at node P and node Q, and observing a substantial difference in the first, but not the second case. In a third example some condensation may occur on the wiring before node P, and dissipate 2 W of power. The system would observe the difference between the power delivered by node 9, and the power transmitted by node P of 2 W. This may cause the system to alert the user to this condition. The 2 W may cause the evaporation of the condensation and the fault may disappear. It should be noted that in all these cases the lost power is substantially below the capacity of the circuit, but in some cases may be enough to be a hazard. It may be decided that a small fault power may be tolerated for a longer period of time than a large fault, and that some errors may be present in the measurements, and therefore in order to prevent false alarms the threshold for action may be set sufficiently high that the alarm is not triggered by normal errors in measurement.

The determination of whether to provide an alert or trip the breaker may take into account factors such as system load and characteristics, duration and/or system measurement errors, as well as other factors. Accordingly, it may be appreciated that, for example, an alert may be provided where a small amount of power is “lost” over a long period of time, or a large amount of power is “lost” quickly. It may also be appreciated that a plurality of nodes may be identified as being associated with the breaker and the power consumption for each of the nodes may be identified. Accordingly, if one of a plurality of nodes is “losing” power, that node may be identified and the problem remedied.

The foregoing description has been presented for purposes of illustration. It is not intended to be exhaustive or to limit the disclosure to the precise steps and/or forms disclosed, and obviously many modifications and variations are possible in light of the above teaching. It is intended that the scope of the invention be defined by the claims appended hereto.

What is claimed is:

1. A system for determining the electrical connections for a network of wired nodes comprising:
an electrical power distribution system;
a plurality of nodes connected to said power distribution system;
each of said nodes configured to supply and detect a node electrical signal such that the direction from which said node electrical signal was supplied can be ascertained;
said system configured to identify the wiring configuration of said nodes relative to other nodes based upon said node electrical signal.

2. The system of claim 1 wherein said system includes a processor for identifying said wiring configuration of said nodes relative to other nodes.

3. The system of claim 2 wherein said processor is a central processor.

4. The system of claim 3, wherein said central processor is positioned in a breaker supply panel and is configured to communicate via one or more phases simultaneously.

5. The system of claim 2, wherein each of said nodes includes a processor and said plurality of processors identify said wiring configuration of said nodes relative to other nodes.

6. The system of claim 1, wherein each of said nodes is configured to communicate its state to the system.

7. The system of claim 1 wherein said node electrical signal is a voltage signal generated by said node and modified to create a different signal upstream versus downstream.

8. The system of claim 1 wherein said node electrical signal is an incremental load.

9. The system of claim 1, wherein said system is further configured to map said nodes to a location associated with a physical location.

10. The system of claim 1, further comprising a breaker in communication with at least one of said plurality of nodes, wherein if said breaker is tripped, said breaker is configured to provide communication from said breaker to at least one node.

11. The system of claim 10, wherein said node is self powered and configured to communicate when said breaker is tripped.

12. The system of claim 10, wherein said breaker is configured to provide power to said node(s) when said breaker is tripped.

13. The system of claim 2, wherein said processor is configured to initiate a roll call, identifying said plurality of nodes, and synchronize said plurality of nodes by issuing a synchronization command wherein each of said nodes is configured to record a line cycle number at the time of receiving said synchronization command.

14. The system of claim 1, further configured to:
characterize a load attached to a node based on one or more of the following characteristics and/or their cross correlation: power usage, current draw, power factor, duty cycle, start up current, shut down current, standby power, line voltage, current wave form, time of day, date, location and/or environmental conditions; and
create a use profile over time from which departures over time can be detected and one of the following actions may be taken: an alert may be sent, the change may be ignored, the change may be recorded or power may be shut off.

15. The system of claim 1, further configured to develop a cost profile over time for power consumed by at least one of said nodes.

16. A system for determining the electrical connections for a network of wired nodes comprising:
at least three nodes connected to a common bus;
each of said nodes configured to supply and detect a node electrical signal along said common bus such that the direction from which said node electrical signal was supplied can be ascertained;
said system configured to identify the wiring configuration of said nodes relative to other nodes based upon said node electrical signal.

17. The system according to claim 16, wherein there is more than one common bus.

18. A node comprising:
a conductive pathway;
a sensor in communication with said conductive pathway configured to measure current in said conductive patheway and/or voltage between said conductive pathway and another location;
a switchable load connected between said conductive pathway and another location;
a microcontroller in communication with said sensor and said switchable load, configured to send and receive a node electrical signal such that the directionality of signals sent from other such nodes may be ascertained.

19. The node of claim 18, wherein said node includes a user detectable signal.

20. The node of claim 18, wherein said conductive pathway passes through said node.

21. The node of claim 18, wherein said conductive pathway passes from said node to an electrical load.

22. The node of claim 18, wherein said conductive pathway passes around said node and said sensor is tethered to said node.

23. A method for identifying unintended power dissipation comprising:
identifying at least one upstream node and at least one downstream node;
identifying power transmitted through said upstream node to be delivered to said downstream node;
determining a difference between the power transmitted by said upstream node and the power drawn from and through said downstream node; and
determining if there is a unsafe level of unintended power dissipation and providing an alert and/or removing power from a node upstream of where the unintended power dissipation may have occurred.

24. The method of claim 23 including identifying a plurality of downstream nodes associated with said upstream node and summing the power drawn from or through said downstream nodes and determining the difference between said power transmitted by said upstream node and the sum of the power drawn from or through said downstream nodes.

25. A method for mapping comprising:
providing a plurality of nodes on a power distribution network, each of said nodes configured to supply and detect a node electrical signal and a processor for identifying said wiring configuration of said nodes relative to other nodes;
initiating a roll call, identifying said plurality of nodes based upon said node electrical signals; and
identifying a wiring configuration of said nodes relative to other nodes based upon said node electrical signals.
